(19) United States
(12) Patent Application Publication
(10) Pub. No.: US 2006/0057462 A1
(43) Pub. Date: Mar. 16, 2006

(54) Lithium ion secondary battery

(76) Inventor: Ki Yuon Jeon, Youngin-si (KR)

Correspondence Address: CHRISTIE, PARKER & HALE, LLP, PO BOX 7068, PASADENA, CA, 91109-7068, US

(21) Appl. No.: 11/223,793

(22) Filed: Sep. 8, 2005

(30) Foreign Application Priority Data
Sep. 8, 2004 (KR) 10-2004-0071774

(51) Int. Cl. H01M 2/08; H01M 2/36

(52) U.S. Cl. 429/185; 429/175; 429/72

(57) ABSTRACT

A lithium ion secondary battery is provided. The battery comprises a cap assembly having a cap plate with a predetermined thickness and a predetermined ratio of the length of the long axis to the length of the short axis of the cap plate. This construction prevents deformation of the cap plate, which can occur during sealing of the electrolyte injection hole. The lithium ion secondary battery includes a jelly-roll type electrode assembly having first and second electrode plates and a separator positioned between the electrode plates. The battery further comprises a battery case for containing the electrode assembly, and a cap assembly having a cap plate comprising an alloy of aluminum and manganese. The alloy contains 2% or less manganese. The cap assembly includes a terminal portion coupled to the battery case to seal the case, and the cap assembly is electrically connected to the electrode assembly.

### CROSS-REFERENCE TO RELATED APPLICATION

This application claims priority to and the benefit of Korean Patent Application No. 2004-0071774, filed on Sep. 8, 2004, in the Korean Intellectual Property Office, the entire content of which is incorporated herein by reference.

### FIELD OF THE INVENTION

The present invention relates to a secondary battery, and more particularly to a lithium ion secondary battery having a cap assembly adapted to prevent the cap plate from deforming when the electrolyte injection hole is sealed. The cap assembly comprises a cap plate having a predetermined thickness and a predetermined ratio of the length of the long axis to the length of the short axis of the cap plate.

### BACKGROUND OF THE INVENTION

Light, compact electric and electronic appliances including cellular phones, laptop computers, and camcorders have recently been actively developed and produced. Such portable electric and electronic appliances operate on battery packs when separate power supplies are unavailable. For economic reasons, the battery pack generally comprises a secondary battery, which can be charged and discharged. Exemplary secondary batteries include nickel-cadmium (Ni—Cd) batteries, nickel-hydrogen (Ni-MH) batteries, lithium (Li) batteries, and lithium ion batteries.

Lithium secondary batteries operate at voltages of 3.6 V, a voltage three times greater than that of nickel-hydrogen batteries and nickel-cadmium batteries which are widely used as power supplies for portable electronic appliances. Lithium secondary batteries also have high energy density per unit weight. For these reasons, use of lithium secondary batteries has increased.

Lithium secondary batteries use primarily lithium-based oxides as positive electrode active materials and carbon materials as negative electrode active materials. Lithium secondary batteries are classified according to the type of electrolyte used, namely, lithium ion batteries use liquid electrolytes, and lithium polymer batteries use polymer electrolytes. Lithium secondary batteries can take various shapes, including cylinders, rectangles, and pouches.

A typical lithium ion secondary battery includes an electrode assembly having a positive electrode plate coated with a positive electrode active material, a negative electrode plate coated with a negative electrode active material, and a separator positioned between the positive and negative electrode plates. The separator prevents short circuits and allows only lithium ions to pass. The lithium secondary battery also comprises a battery case for containing the electrode assembly and an electrolyte for enabling movement of lithium ions, which electrolyte is injected into the battery case.

A positive electrode tab is connected to the positive electrode plate, which is coated with a positive electrode active material. A negative electrode tab is connected to the negative electrode plate, which is coated with a negative electrode active material. The electrode assembly is manufactured by laminating the positive electrode plate with the positive electrode tab attached, the negative electrode plate with the negative electrode tab attached, and the separator. After lamination, the positive and negative electrode plates and the separator are wound to form the electrode assembly.

Thereafter, the electrode assembly is contained in the battery case and the opening of the case is closed with a cap assembly to prevent the electrode assembly from escaping. An electrolyte is injected into the battery case through an electrolyte injection hole positioned on a cap plate of the cap assembly. An aluminum ball, which has excellent ductility, is then inserted into the electrolyte injection hole to seal the hole. The aluminum ball may be welded to the injection hole, or a resin may be used to enhance sealing.

However, it has recently been discovered that sealing the electrolyte injection hole by inserting a ball into the hole causes severe deformation of the cap plate. Such deformation of the cap plate results primarily from a decrease in mechanical strength, which occurs when the thickness of the cap plate is decreased. Decreasing the thickness of the cap plate reduces battery size but increases charging capacity.

When the cap plate severely deforms, the seal between the case and the cap plate may fail. In addition, the deformed cap plate may put pressure on the upper surface of the electrode assembly, contained within the battery case, thereby generating a short circuit between the positive and negative electrodes. Furthermore, the internal pressure of the battery case may vary, and the safety vent may fracture even during normal charge or discharge cycles.

### SUMMARY OF THE INVENTION

In one embodiment, the present invention provides a lithium ion secondary battery having a cap assembly comprising a cap plate having a predetermined thickness and a predetermined ratio of the length of the long axis to the length of the short axis of the cap plate. This construction prevents the cap plate from deforming upon sealing the electrolyte injection hole.

A lithium ion secondary battery according to one embodiment includes a jelly-roll type electrode assembly having first and second electrode plates and a separator positioned between the first and second electrode plates. The battery further includes a battery case for containing the electrode assembly, and a cap assembly having a cap plate coupled to the case to seal the case. The cap plate comprises an alloy of aluminum and manganese containing 2% or less manganese.

According to another embodiment of the present invention, a lithium ion secondary battery includes a wound (jelly-roll type) electrode assembly having first and second electrode plates and a separator positioned between the electrode plates. The battery further comprises a battery case for containing the electrode assembly, and a cap assembly having a cap plate electrically connected to the electrode assembly and coupled to the case to seal the case. The cap plate comprises a material having a yield strength of at least about 15.00 kg_{f}/mm².

In one embodiment, the cap plate has a thickness ranging from about 0.7 to about 1.1 mm. The ratio of the length of the long axis to the length of the short axis of the cap plate may range from about 1.3 to about 4.0. In another embodiment, the ratio is about 3.0 or less.

The cap plate may comprise a material selected from the group consisting of a material having a tensile strength of at least 15.50 kg_{f}/mm², a material having a shear strength of at least 10.00 kg_{f}/mm², and a material having a Brinell hardness of at least 40.

### BRIEF DESCRIPTION OF THE DRAWINGS

The above and other features and advantages of the present invention will become more apparent by reference to the following detailed description when considered in conjunction with the accompanying drawings, in which:

FIG. 1 is a schematic perspective view of a lithium secondary battery according to one embodiment of the present invention; and

FIG. 2 is a perspective view of a cap plate of a lithium ion secondary battery according to one embodiment of the present invention.

### DETAILED DESCRIPTION

Exemplary embodiments of the present invention will now be described with reference to the accompanying drawings. In the following description and drawings, like reference numerals are used to designate like components in order to avoid repetitive descriptions of same or similar components.

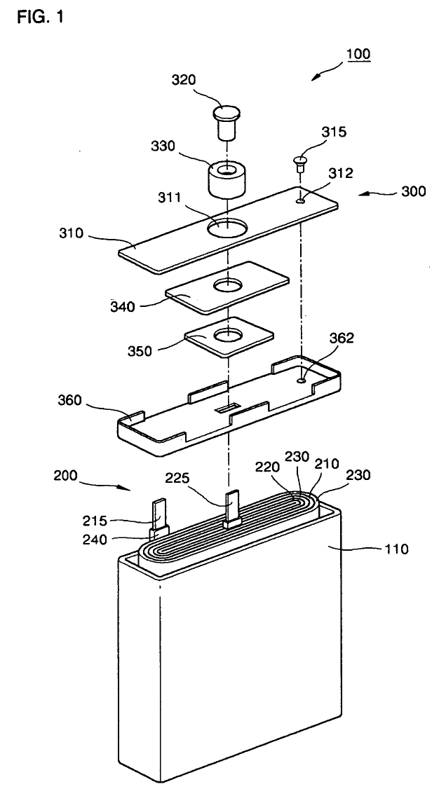

FIG. 1 is a schematic perspective view of a lithium secondary battery according to one embodiment of the present invention. As shown in FIG. 1, a lithium secondary battery 100 includes a battery case 110, a jelly-roll type electrode assembly 200 contained in the battery case 110, and a cap assembly 300 coupled to the top of the battery case 110.

The battery case 110 comprises a metallic material and has an approximately square shape. The case 110 itself may act as a terminal.

The electrode assembly 200 comprises a first electrode plate 210 having a first electrode tab 215 (or positive electrode tab) attached thereto, a second electrode plate 220 having a second electrode tab 225 attached thereto, and a separator 230 positioned between the first and second electrode plates 210 and 220, respectively. The positive and negative electrode plates and the separator are laminated together and wound to form the electrode assembly 200. The electrode assembly 200 is contained in the battery case 110. The portions of the first and second electrode tabs 215 and 225, respectively, which extend from the electrode assembly 200, can be insulated from the electrode assembly 200 by insulation tapes 240 to avoid short circuits between the first and second electrode plates 210 and 220, respectively.

The cap assembly 300 includes a flat cap plate 310 sized and shaped to correspond to the opening of the battery case 110. The cap plate 310 has a terminal through-hole 311 at its center and an electrolyte injection hole 312 on one side for injecting an electrolyte. The electrolyte injection hole 312 is sealed by inserting a plug 315 in the hole 312.

The terminal through-hole 311 is positioned such that an electrode terminal 320 (for example, a negative electrode terminal) can be inserted through the through-hole 311. A tubular gasket 330 surrounds the electrode terminal 320, electrically insulating the terminal from the cap plate 310. An insulation plate 340 is positioned beneath the cap plate 310, and a terminal plate 350 is positioned between the insulation plate 340 and the opening of the battery case 110.

The electrode terminal 320 is inserted through the terminal through-hole 311. The gasket 330 surrounds the outer peripheral surface of the terminal 320. The electrode terminal 320 extends through the insulation plate 340 and is electrically connected at its lower end to the terminal plate 350.

The first electrode tab 215, which extends from the first electrode plate 210, is welded to the lower surface of the cap plate 310, and the second electrode tab 225, which extends from the second electrode plate 220, is welded to the lower end of the electrode terminal 320.

An insulation case 360 is positioned over the opening of the battery case 110, and covers the electrode assembly 200. The insulation case 360 electrically insulates the electrode assembly 200 from the cap assembly 300. The insulation case 360 has an electrolyte injection hole 362 corresponding in position to the position of the electrolyte injection hole 312 of the cap plate 310, enabling easy electrolyte injection. The insulation case 360 may comprise a polymer resin having insulative properties, for example polypropylene.

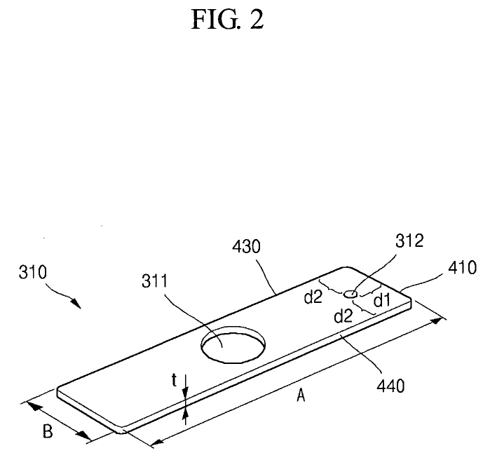

FIG. 2 is a perspective view of a cap plate of a lithium ion secondary battery according to one embodiment of the present invention. As shown in FIG. 2, the cap plate 310 has a terminal through-hole 311 and an electrolyte injection hole 312.

The cap plate 310 comprises a material having a yield strength of at least about 15.00 kg_{f}/mm². In one embodiment, the cap plate 310 comprises an alloy of aluminum and manganese containing about 2% or less of manganese. The yield strength of the material is particularly important because the cap plates 310 have thicknesses ranging from about 0.7 to about 1.1 mm. The cap plates 310 may also have thicknesses ranging from about 0.7 to about 0.8 mm, in which range the cap plate is vulnerable to deformation, making the yield strength even more critical.

According to one embodiment of the present invention, the ratio of the length of the long axis A to the length of the short axis B of the cap plate 310 may be about 4.0 or less. In another embodiment the ratio is about 3.3 or less, and in yet another embodiment the ratio is 3.0. If the ratio is larger than 4.0, the cap plate 310 easily deforms in the direction of the long axis A when the electrolyte injection hole 312 is sealed. If the ratio is 3.3 or less, deformation does not easily occur, and when the ratio is 3.0, very little deformation occurs.

In one embodiment, the electrolyte injection hole 312 is positioned on the cap plate such that the distance (d1) between the hole 312 and a first end 410 of the plate 310 is shorter than the distance (d2) between the hole 312 and either of the first and second sides 430 and 440, respectively, of the cap plate 310.

In one embodiment, the ratio of the length of the long axis A to the length of the short axis B of the cap plate 310 is at least 1.3. In another embodiment, the ratio is at least 1.5. If the ratio is less than 1.3, the cap plate's resistance to torque decreases.

The cap plate 310 may comprise either a material having a tensile strength of at least 15.50 kg_{f}/mm², a material having a shear strength of at least 10.00 kg_{f}/mm², or a material having a Brinell hardness of at least 40.

The plug used to seal the electrolyte injection hole can comprise aluminum, for example JIS 1070 aluminum, which has excellent ductility. The plug can have a Vickers hardness of about 26 to about 27. Preferably, the plug protrudes about 0.15 mm or less from the surface of the cap plate, enabling easy laser welding upon sealing.

The cap plates of the present invention resist deformation during coupling of the cap plate 310 to the top of the battery case 110, during injection of the electrolyte, and during sealing of the electrolyte injection hole 312 with a plug 315.

In summary, the lithium ion secondary batteries according to the present invention can prevent the cap plate 310 from deforming when inserting the plug 315 into the electrolyte injection hole 312. To prevent such deformation, the cap plates of the present invention have predetermined thicknesses and predetermined ratios of the lengths of the long axes to the lengths of the short axes of the cap plates.

Exemplary embodiments of the present invention have been described for illustrative purposes only. Those skilled in the art will appreciate that various modifications, additions and substitutions can be made without departing from the spirit and scope of the invention as disclosed in the accompanying claims.

What is claimed is:

1. A lithium ion secondary battery comprising:
an electrode assembly having first and second electrode plates and a separator positioned between the first and second electrode plates;
a battery case for containing the electrode assembly; and
a cap assembly having a cap plate comprising an alloy of aluminum and manganese, the alloy comprising about 2% or less manganese, wherein the cap assembly is coupled to the battery case to seal the battery case, the cap assembly being electrically connected to the electrode assembly.

2. The lithium ion secondary battery as claimed in claim 1, wherein the cap plate has a thickness ranging from about 0.7 to about 1.1 mm.

3. The lithium ion secondary battery as claimed in claim 1, wherein the ratio of a length of a long axis and a short axis of the cap plate ranges from about 1.3 to about 4.0.

4. The lithium ion secondary battery as claimed in claim 1, wherein the cap plate comprises a material having a tensile strength of at least about 15.50 kg_{f}/mm².

5. The lithium ion secondary battery as claimed in claim 1, wherein the cap plate comprises a material having a shear strength of at least about 10.00 kg_{f}/mm².

6. The lithium ion secondary battery as claimed in claim 1, wherein the cap plate comprises a material having a Brinell hardness of at least 40.

7. A lithium ion secondary battery comprising:
an electrode assembly having first and second electrode plates and a separator positioned between the first and second electrode plates;
a battery case for containing the electrode assembly; and
a cap assembly having a cap plate comprising a material having a yield strength of at least about 15.00 kg_{f}/mm², wherein the cap assembly is coupled to the case to seal the battery case, the cap assembly being electrically connected to the electrode assembly.

8. The lithium ion secondary battery as claimed in claim 7, wherein the cap plate comprises a material having a tensile strength of at least about 15.50 kg_{f}/mm².

9. The lithium ion secondary battery as claimed in claim 7, wherein the cap plate comprises a material having a shear strength of at least about 10.00 kg_{f}/mm².

10. The lithium ion secondary battery as claimed in claim 7, wherein the cap plate comprises a material having a Brinell hardness of at least 40.

11. The lithium ion secondary battery as claimed in claim 7, wherein the cap plate has a thickness ranging from about 0.7 to about 1.1 mm.

12. The lithium ion secondary battery as claimed in claim 7, wherein the ratio of a length of a long axis and a length of a short axis of the cap plate ranges from about 1.3 to about 4.0.

13. The lithium ion secondary battery as claimed in claim 12, wherein the ratio of a length of a long axis and a length of a short axis of the cap plate ranges from about 1.5 to about 3.3.

14. The lithium ion secondary battery as claimed in claim 13, wherein the ratio of a length of a long axis and a length of a short axis of the cap plate is 3.0.

15. The lithium ion secondary battery as claimed in claim 7, wherein the cap plate comprises an electrolyte injection hole positioned such that a first distance between the electrolyte injection hole and a first end of the cap plate is shorter than a second distance between the electrolyte injection hole and first and second sides of the cap plate.

16. The lithium ion secondary battery as claimed in claim 7, wherein the cap plate comprises an alloy of aluminum and manganese, wherein the alloy comprises about 2% or less manganese.

17. A lithium ion secondary battery comprising:
an electrode assembly having first and second electrode plates and a separator positioned between the first and second electrode plates;
a battery case for containing the electrode assembly; and
a cap assembly having a cap plate comprising a material selected from the group consisting of:
a material having a yield strength of at least about 15.00 kg_{f}/mm²,
an alloy of aluminum and manganese, wherein the alloy comprises about 2% or less manganese,
a material having a Brinell hardness of at least 40,
a material having a shear strength of at least about 10.00 kg_{f}/mm²,
a material having a tensile strength of at least about 15.50 kg_{f}/mm², and mixtures thereof,
wherein the cap assembly is coupled to the case to seal the battery case, the cap assembly being electrically connected to the electrode assembly.

18. The lithium ion secondary battery as claimed in claim 17, wherein the cap plate has a thickness ranging from about 0.7 to about 1.1 mm.

19. The lithium ion secondary battery as claimed in claim 17, wherein the ratio of a length of a long axis and a length of a short axis of the cap plate ranges from about 1.3 to about 4.0.
